(19) United States
(12) Patent Application Publication
(10) Pub. No.: US 2026/0120157 A1
(43) Pub. Date: Apr. 30, 2026

(54) Generation of a Meta-Catalog Using a Large Language Model

(71) Applicant: Maplebear Inc., San Francisco, CA (US)

(72) Inventor: Naval Shah, Toronto (CA)

(21) Appl. No.: 18/933,697

(22) Filed: Oct. 31, 2024

(51) Int. Cl. G06Q 30/0601

(52) U.S. Cl. CPC G06Q 30/0603; G06Q 30/0613; G06Q 30/0629; G06Q 30/0631; G06Q 30/0633; G06Q 30/0643

(57) ABSTRACT

An online system leverages a large language model (LLM) to generate a meta-catalog using online catalogs of items that are associated with sources. Items from the online catalogs are clustered. The clustering is based in part on similarity of the items, and each cluster is associated with a different meta-product. The LLM is prompted, based on descriptions of the items, to generate descriptions for meta-products that are associated with the clusters. Entries for the meta-products are generated using the generated descriptions. The meta-catalog for the meta-products is generated using the entries. The meta-catalog is provided to a third party system. A user may interact with the third party system via a user client device to select a meta-product of the meta-catalog for purchase, and the user client device is redirected to the online system to select an item corresponding to the meta-product and complete an order for the item.

### BACKGROUND

Conventional online platforms may sell products for multiple different retailers. To do so, conventional online platforms maintain a plurality of different product catalogs. For example, a conventional online platform may maintain a different product catalog for in-store shopping for each retail location of a retailer, in addition to a separate catalog for online shopping at the retailer. As such, if a single retailer has 40 store locations, just for that retailer, a conventional online platform may maintain 41 different product catalogs. A conventional online platform may source products from hundreds or even thousands of different retailers, accordingly, a conventional online platform typically maintains a very large number of product catalogs. Such a large number of product catalogs can make it very difficult to integrate for use with third party systems (e.g., as part of some target customer experience on a third party system). Additionally, retailers may object to some of their information (e.g., pricing information, availability information) being shared with third party systems, thereby potentially preventing integration of the product catalogs with third party systems.

### SUMMARY

In accordance with one or more aspects of the disclosure, an online system leverages a large language model to generate a meta-catalog. A meta-catalog includes a plurality of entries for different meta-products. A meta-product is a generic representation of a plurality of similar items from various online catalogs of items (e.g., of various sources) maintained by the online system. Meta-products are composed of descriptions, and in some cases meta-product images, but do not include item data (e.g., pricing information and availability information of items associated with the meta-products).

The online system may cluster items into a plurality of clusters. The clustering is based in part on similarity of the items, and each cluster is associated with a different meta-product. The online system may prompt, based in part on descriptions of the items, a large language model to generate descriptions for meta-products that are associated with the plurality of clusters. The online system may generate entries for the meta-products using in part the generated descriptions. The online system may assemble a meta-catalog for the meta-products using the entries. The online system may provide the meta-catalog to one or more third party systems.

A user may interact with a third party system, of the one or more third party systems, via a user client device to select a meta-product of the meta-catalog for purchase. The user client device may be redirected to the online system to select an item corresponding to the meta-product and complete an order for the selected item.

A single, relatively simple, catalog can be easily integrated into and used by third party systems as they do not have to deal with the complexity of managing potentially thousands of different, detailed, online catalogs for items from various sources. Accordingly, by providing the meta-catalog (versus the plurality of online catalogs of items) to third party systems, the online system makes it easier for the third party systems to integrate and use the meta-catalog on their respective platforms. Moreover, sources may not want to share item data (e.g., pricing information and availability information of items) with some or all of the third party systems. As noted above the meta-product catalog does not include item data and instead just includes descriptions of meta-products, and may also include meta-product images for the meta-products. Accordingly, the meta-product catalog not only simplifies integration with third party systems, but it also helps mitigate distribution of item data (e.g., pricing information and availability information) of to third party systems.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIG. 3 forms an example sequence diagram describing generation of a meta-catalog using a plurality of online catalogs of items, in accordance with some embodiments.

FIGS. 4A-4B form an example sequence diagram describing use of a meta-catalog, in accordance with some embodiments.

FIG. 5A illustrates an interface of a third party system that is presenting meta-products from a meta-catalog, in accordance with some embodiments.

FIG. 5B illustrates an example ordering interface presenting item recommendations for items corresponding to meta-products, in accordance with some embodiments.

FIG. 6 is a flowchart for a method of generation of a meta-catalog using a large language model, in accordance with some embodiments.

### DETAILED DESCRIPTION

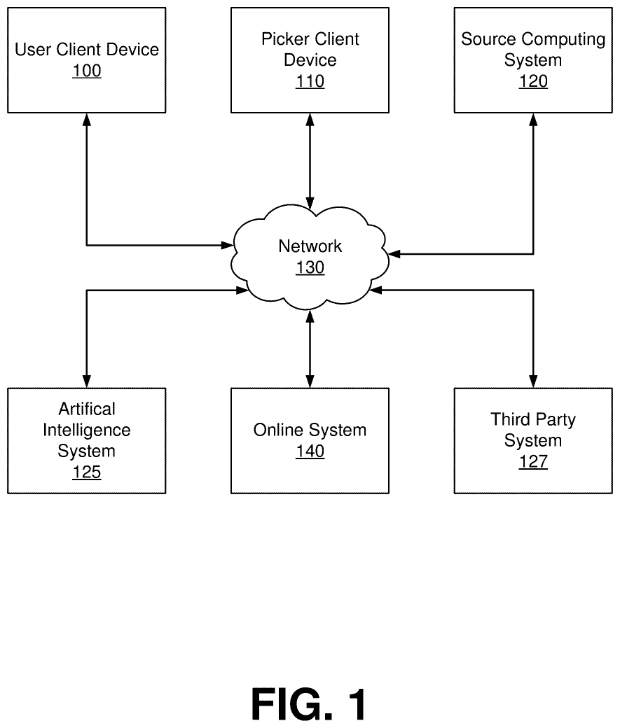

FIG. 1 illustrates an example system environment for an online system 140, in accordance with one or more embodiments. The system environment illustrated in FIG. 1 includes a user client device 100, a picker client device 110, a source computing system 120, an artificial intelligence (AI) system 125, a third party system 127, a network 130, and an online system 140. Alternative embodiments may include more, fewer, or different components from those illustrated in FIG. 1, and the functionality of each component may be divided between the components differently from the description below. For example, some or all of the functionality of the AI system 125 may be performed by the online system 140. Additionally, each component may perform their respective functionalities in response to a request from a human, or automatically without human intervention.

Although one user client device 100, picker client device 110, source computing system 120, AI system 125, and third party system 127 are illustrated in FIG. 1, any number of users, pickers, sources, AI systems, and third party systems may interact with the online system 140. As such, there may be more than one user client device 100, picker client device 110, source computing system 120, AI system 125, or third party system 127.

A meta-catalog includes a plurality of entries for different meta-products. A meta-product is a generic representation of a plurality of similar items (e.g., having a same item category) in various online catalogs of items maintained by the online system 140. A meta-product includes a meta-description of the meta-product, and in some embodiments, may also include a meta-product image of the meta-product. A meta-description generally describes the meta-product (e.g., a name and synopsis of the meta-product), and the meta-product image of the meta-product is a generic image of the meta-product. The meta-product does not include item data (e.g., pricing and availability information) of the items of the cluster associated with the meta-product. The meta-description and the meta-product image are produced using a large language model.

For example, a meta-product may be for “Greek Yogurt.” A meta-description for “Greek Yogurt” may be: “Experience the delightful simplicity and versatility of Greek Yogurt, crafted with care and tradition to bring you a rich and creamy texture that's unmistakably smooth. Our Greek Yogurt boasts a high protein content, perfect for those looking to enrich their diet without compromising on taste. With minimal sugar, it's an ideal choice for a health-conscious lifestyle, offering a guilt-free indulgence whether enjoyed on its own, paired with fruit or cereal, or used as a creative ingredient in your culinary creations. Free from artificial colors, flavors, and gelatin, this yogurt is a testament to the purity and quality of its ingredients. Available in various fat contents to cater to your preference, each serving is designed to inspire and satisfy, making it a staple in any kitchen for snacks or elaborate dishes. Discover the unmatched versatility and delightful taste of our Greek Yogurt, and let it inspire your next meal, snack, or culinary adventure.” And a corresponding meta-product image for “Greek Yogurt” may be an image generated by the large language model of a container of yogurt with some generic text (e.g., a name (“Greek Yogurt”), a container size (e.g., 750 ml), etc.). The meta-product image and the meta-description, of a meta-product, are both generic and are not specific to a particular item (e.g., Brians Organic Non-Fat Greek Yogurt, 100 mL, sold at Bob's Corner Market at 123 Main, Springfield, CA) of the cluster of items associated with the meta-product.

The user client device 100 is a client device through which a user may interact with the picker client device 110, the source computing system 120, the third party system 127, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140. In some embodiments, the user client device 100 may include an application that communicates with the third party system 127.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive data from the third party system 127, where the data is associated with one or more meta-products. For example, the received data may be meta product recommendations for various meta-products. In some embodiments, the data may also include an interface that presents the meta product recommendations. The user client device 100 may interact, e.g., via the interface, with the third party system 127 to select one or more meta-products. The interface may include an option to order items corresponding to selected meta-product(s). Responsive to selection of the option the user client device 100 may be redirected to the online system 140 to continue the order.

Once redirected, the user client device 100 may receive from the online system 140, for each of the selected meta-product(s), one or more corresponding items recommendations to choose from. The user client device 100 may present, via the ordering interface, the received item recommendations to the user. The user may then select specific item recommendation(s) to purchase associated items. For example, if one of the selected meta-products was “Greek Yogurt,” the user client device 100 may receive corresponding item recommendations for specific items (e.g., Brian's Organic Non-Fat Greek Yogurt, 100 mL; Charlie's whole fat Greek Yogurt, 100 mL; etc.) that are available at a source (Bob's Corner Market at 123 Main, Springfield, CA) within a threshold distance from the user. The user may then select one or more of the item recommendations for the item(s), and select an option to complete an order for the item(s). The user client device 100 then coordinates with the online system 140 to complete the order for the item(s).

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The third party system 127 is a computing system operated by a third party company that interacts with the online system 140 or the user client device 100. The third party system 127 uses a meta-catalog from the online system 140 to provide one or more services to its users. For example, the third party system 127 may be a website that stores various recipes. The third party system 127 may map ingredients of the recipes to corresponding meta-products of the meta-catalog. The third party system 127 may provide data to the user client device 100 that includes one or more meta-product recommendations for one or more meta-products. In some embodiments, the third party system 127 may generate an interface, and provide the interface to the user client device 100. A user of the user client device 100 may interact with the third party system 127 (e.g., via the interface) to select meta-product recommendations for meta-products that correspond to ingredients of one or more recipes of interest. The third party system 127 may receive a request to finalize an order from the user client device 100. Responsive to the request, the third party system 127 redirects the user client device 100 to the online system 140 for completion of the order.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data (e.g., availability information) indicating which items are available at a particular source location and the quantities of those items. The provided item data may also include pricing information for the items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The AI system 125 may be configured to apply inputs (e.g., prompts) to one or more machine-learning models to generate responses to the prompts. As used herein, machine-learning model is used interchangeably with “large language model.” The AI system 125 includes one or more machine-learning models. The one or more machine-learning models may be generative machine-learning models.

The AI system 125 may be configured to determine information used to generate meta-catalog entries. For example, the AI system 125 may receive one or more prompts to generate descriptions for meta-products that are associated with different clusters of items based on descriptions (and in some cases container data or size data) of the items. The AI system 125 may apply the one or more prompts to a large language model to generate descriptions for the meta-products. The generated descriptions for the meta-products may be provided to the online system 140.

In some embodiments, the AI system 125 receives one or more prompts to generate meta-product images for the meta-products based in part on the descriptions of the meta-products (and in some cases also container data or size data). The AI system 125 may apply the one or more prompts to the large language model to generate meta-product images for the meta-products. The generated meta-product images for the meta-products may be provided to the online system 140.

The user client device 100, the picker client device 110, the source computing system 120, the AI system 125, the third party system 127, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 generates a meta-catalog of different meta-products. The online system 140 maintains a plurality of different online catalogs of items for a plurality of sources of one or more source computing systems 120. Each item in the plurality of different online catalogs has a corresponding description, and may also include size data (e.g., describes how large an item is) or container data (e.g., describes a container the item is sold in). The online system 140 clusters items of the plurality of different online catalogs into a plurality of clusters. The clustering may be based in part on similarity of the items (e.g., by item category), such that each cluster is associated with a different meta-product and describes all items for that meta-product. For example, there may be a cluster for a meta-product for “Cheddar Cheese” that includes Chuck's Cheddar, 12 oz block, at Bob's Market; Farmhouse English Cheddar, 12 oz Block, at Bob's Market; Island Cheddar, 8 oz, sliced, at Island Market; etc. The online system 140 records the mapping between meta-products and corresponding clusters of items as meta-linking data. The online system 140 prompts, based in part on descriptions of the items (and in some cases also container data or size data), a large language model (e.g., of the AI system 125) to generate descriptions for meta-products that are associated with the plurality of clusters. In some embodiments, the online system also prompts the large language model to generate meta-product images for the meta-products based in part on the descriptions of the meta-products (and in some cases also container data or size data). The online system 140 generates entries for the meta-products using in part the generated descriptions for the meta-products, and in some cases also using the generated meta-product images. The online system 140 assembles a meta-catalog for the meta-products using the entries. The online system 140 may provide the meta-catalog to one or more third party systems (e.g., the third party system 127).

The online system 140 is an online system by which users can order items to be provided to them by a picker from a source. The online system 140 may receive a request to finalize an order associated with one or more meta-products, where the order was imitated during an interaction between the user client device 100 and the third party system 127. Responsive to receiving the request, the online system 140 identifies (e.g., using the meta-linking data), for each meta-product, a corresponding cluster of items. The online system 140, for each meta-product, may score the items of the cluster based in part on various criteria (e.g., location of the user, availability of the items at one or more sources within a threshold distance from the location), and rank the scored items. The online system 140 may provide item recommendations for some of the ranked items (e.g., based on their ranking) to the user client device 100. The user may then select one or more of the item recommendations for items that correspond to meta-product(s) and complete the order.

The online system 140 receives orders from the user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

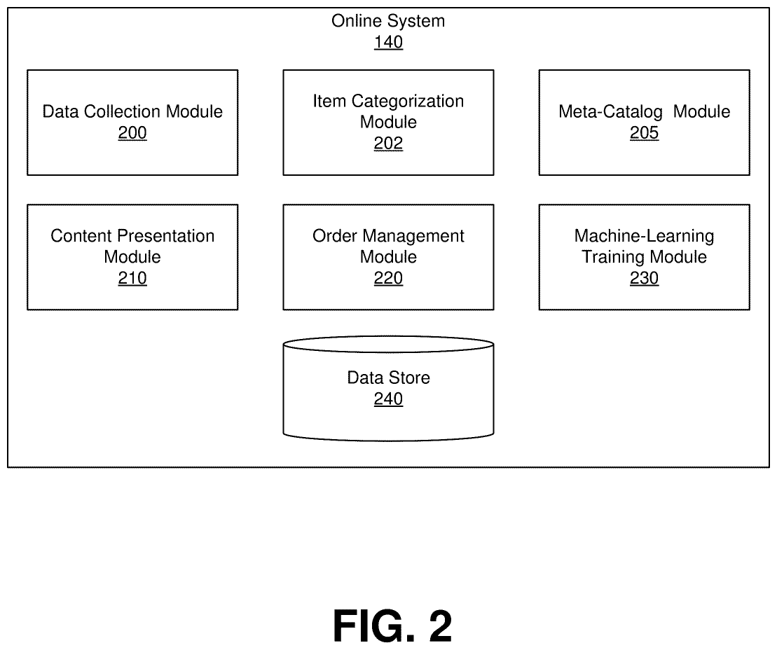

As an example, a user may assemble an order for meta-products on the third party system 127 using the user client device 100. Once the user is ready to finalize the order, the user requests to finalize the order (e.g., selects an option to finalize the order) and the user client device 100 is redirected to the online system 140. The online system 140 identifies (e.g., using the meta-linking data), for each of the meta-products, a corresponding cluster of items. The online system 140, for each meta-product, scores the items of the cluster based in part on various criteria (e.g., location of the user and availability of the items at one or more sources within a threshold distance from the location of the user), and ranks the scored items. The online system 140 provides item recommendations for some of the ranked items (e.g., based on their ranking) to the user client device 100. The user may then select one or more of the item recommendations for items that correspond to meta-products and complete the order. The online system 140 receives the order from the user client device 100 through the network 130. The user's order may specify which items they want to be delivered and from which source (e.g., grocery store) and the quantities of each of the items. The online system 140 selects a picker to travel to the source location to collect the items ordered by the user. The online system 140 transmits an offer to the picker for the picker to service the order in exchange for consideration and, if the picker accepts the offer, the picker collects the items from the source location. Once the picker has collected the items ordered by the user, the picker delivers the items to a location transmitted to the picker client device 110 by the online system 140. The online system 140 is described in further detail below with regards to FIG. 2.

The meta-catalog is a high level generic catalog that includes entries for meta-products and does not include item data (e.g., pricing information for items, availability information for items, etc.). And a single relatively simple catalog can be easily integrated into and used by third party systems as they do not have to deal with the complexity of managing potentially thousands of different, detailed, online catalogs for items from various sources. Accordingly, by providing the meta-catalog (versus the plurality of online catalogs of items) to third party systems, the online system 140 makes it much easier for the third party systems to integrate and use the meta-catalog on their respective platforms. Moreover, sources often have restrictions regarding how their pricing information and availability information is distributed. For example, some sources may object to sharing this information with third party systems. As noted above the meta-product catalog does not include pricing information and availability information of items. Accordingly, the meta-product catalog not only simplifies integration with third party systems, but it also helps mitigate distribution of item data (e.g., pricing information and availability information) of to third party systems.

FIG. 2 illustrates an example system architecture for an online system 140, in accordance with some embodiments. The system architecture illustrated in FIG. 2 includes a data collection module 200, an item categorization module 202, a meta-catalog module 205, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include pricing information for items. The item data may also include availability information for items. For example, the item data may include item identifiers for items that are available and may include quantities of items associated with each item identifier. Additionally, item data may also include attributes of items such as size data, color, weight, stock keeping unit (SKU), container data, or serial number for the item. Size data describes a size of an item. Container data describes a container that the item comes in. For example, the container type (e.g., bag, box, jar, etc.), a material of the container (e.g., plastic, cardboard, etc.), shape of the container, a color of the container, etc. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, meta-products associated with the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The item categorization module 202 determines one or more item categories for items in online catalogs of items maintained by the online system 140. An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the item categorization module 202. In some embodiments, the item categorization module 202 may use a clustering algorithm to determine item categories. The clustering algorithm may score each of the items, and then cluster the items based on their scores, where each cluster is representative of a different item category. In some embodiments, the item categorization module 202 may use a replacement model to determine an item category of an item. The replacement model may be, e.g., a large language model. In some embodiments, the replacement model may have a two-tower configuration. The item categorization module 202 may embed the determined item category into the item data of items. In this manner, the item categorization module 202 may determine item categories for each of the items of the plurality of online catalogs.

The meta-catalog module 205 generates a plurality of clusters that describe different meta-products. A meta-product is a generic representation of similar items (e.g., having a same item category) that are in one or more online catalogs of items maintained by the online system 140. The meta-catalog module 205 may retrieve from the data store 240 a plurality of different online catalogs of items for one or more sources of one or more source computing systems 120. The meta-catalog module 205 clusters items of the plurality of different online catalogs into a plurality of clusters. The clustering may be based in part on similarity of the items, such that each cluster is associated with a different meta-product and describes all items for that meta-product. For example, the meta-catalog module 205 may group items from the plurality of online catalogs of items by item category (e.g., one cluster that includes items with an item category of “milk,” another cluster that includes items with an item category of “Greek Yogurt,” etc.). In another embodiment, the meta-catalog module 205 may determine similarities across one or more sets of characteristics of items (e.g., item category, size, weight, etc.), and based on the determined similarities cluster the items. In this manner, the meta-catalog module 205 generates clusters of items, where each cluster of items is associated with a different meta-product. The meta-catalog module 205 records the mapping between meta-products and corresponding clusters of items as meta-linking data. The meta-catalog module 205 stores the meta-linking data in the data store 240.

The meta-catalog module 205 uses a large language model (e.g., of the AI system 125) to determine information used to generate meta-catalog entries (entries). The meta-catalog module 205 retrieves descriptions (and in some cases container data or size data) of the items from associated item data. The meta-catalog module 205 prompts, based in part on descriptions of the items (and in some cases also the container data or the size data), the large language model to generate descriptions for meta-products that are associated with the plurality of clusters. In some embodiments, meta-catalog module 205 also prompts the large language model to generate meta-product images for the meta-products based in part on the descriptions of the meta-products (and in some cases also container data or size data).

The meta-catalog module 205 may also post process meta-product images to identify and remove extraneous text. In some instances, the large language model may output meta-product images that include text that is not relevant to the meta-product. The meta-catalog module 205 may use, e.g., object character recognition to identify text in a meta-product image. The meta-catalog module 205 analyzed the text to determine whether or not it is extraneous. Text determined to be extraneous may then be removed (e.g., by the meta-catalog module 205) from the meta-product image.

The meta-catalog module 205 generates meta-catalog entries (“entries”) for the meta-products, such that each meta-product has a corresponding entry. The meta-catalog module 205 generates entries for the meta-products using in part the generated descriptions (e.g., a name and synopsis of the meta-product) for the meta-products, and in some cases also using the generated meta-product images.

The meta-catalog module 205 assembles a meta-catalog for the meta-products using the entries. The meta-catalog module 205 provides the meta-catalog to third party system(s) (e.g., the third party system 127). The third party system(s) may integrate or use the meta-catalog to provide services on their respective platforms.

The content presentation module 210 selects content for presentation to a user. For example, the content presentation module 210 selects which items to present to a user while the user is placing an order. The order may originate from a third party system (e.g., and be redirected to the online system 140). For example, the content presentation module 210 may receive a request to finalize an order associated with one or more meta-products. Responsive to receiving the request, the content presentation module 210 identifies, for each of the one or more meta-products, a corresponding cluster of items. The content presentation module 210 may use meta-linking data to determine which clusters of items map to the one or more meta-products. The content presentation module 210 may then retrieve item data for items in the identified clusters. The content presentation module 210 may, for each of the one or more meta-products, score the items of the cluster associated with the meta-product based in part on various criteria (e.g., location of the user, availability of the items at one or more sources within a threshold distance from the location, user preferences, etc.), and then rank the scored items. The content presentation module 210 may select one or more items from each ranked set of items for each cluster, and generate item recommendations for the selected one or more items.

The content presentation module 210 generates and transmits an ordering interface for the user to order items. The content presentation module 210 populates the ordering interface with item recommendations for items (e.g., corresponding to the selected one or more items) that the user may select for adding to their order.

In some embodiments, the content presentation module 210 presents a catalog of all items that are available to the user, which the user can browse to select items to order. The content presentation module 210 also may identify items that the user is most likely to order (e.g., of those that correspond to a meta-product) and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. The item selection model may be used to filter items associated with the clusters. In some embodiments, the item selection model uses item embeddings describing items (e.g., availability, location of source, etc.) and user embeddings (e.g., user location, user preferences) describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, two-tower model, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, meta-product data, or order data, which may be referred to respectively as, training user data, training picker data, training item data (e.g., descriptions of items, size data, container data, etc.), and training order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may train the large language model used to generate information for the entries for meta-products by accessing a set of training examples including training item data (e.g., descriptions of items, size data, container data) for items in a set of training clusters, where each training cluster of the set of training clusters includes a respective subset of the items and is associated with a different training meta-product. The machine-learning training module 230 may apply the large language model to the set of training examples to generate a training output corresponding to a set of predicted information (e.g., descriptions or meta-product images) for training meta-products. The machine-learning training module 230 may back-propagate one or more error terms obtained from one or more loss functions to update a set of parameters of the large language model. The one or more of the error terms may be based on a difference between a label applied to a test interaction of the set of training examples and the set of predicted descriptions for training meta-products. The machine-learning training module 230 may stop the back-propagation after the one or more loss functions satisfy one or more criteria.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

For example, the machine-learning training module 230 may re-train the large language model that is used to generate information for the entries for meta-products. The machine-learning training module 230 may generate training examples based on meta-products selected by users in orders and corresponding items the users selected to fulfill the orders. The machine-learning training module 230 may label each training example based on a comparison of a resolution of the training example to a metric (e.g., conversion of an item the online system 140 had presented as corresponding to a meta-product). The machine-learning training module 230 may retrain the large language model using the labeled training examples.

In some embodiments, the meta-catalog module 205 may prompt, based in part on descriptions of a subset of the items, the large language model to generate descriptions for meta-products that are associated with clusters, of the plurality of clusters, that are associated with the subset of the items. The meta-catalog module 205 may update entries for the meta-products that are associated with the clusters using in part the generated descriptions for the meta-products that are associated with clusters. The meta-catalog module 205 may update the meta-catalog with the updated catalog entries. The meta-catalog module 205 may redistribute at least the updated portion of the meta-catalog to the third party system(s) 127.

The data store 240 stores data used by the online system 140. For example, the data store 240 stores user data, item data, order data, meta-linking data, a meta product catalog, entries for the meta-product catalog, descriptions for meta-products, meta-product images for meta-products, and picker data for use by the online system 140. The data store 240 also stores trained machine-learning models (e.g., the large language model used to generate information for the entries for meta-products, replacement model, etc.) trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

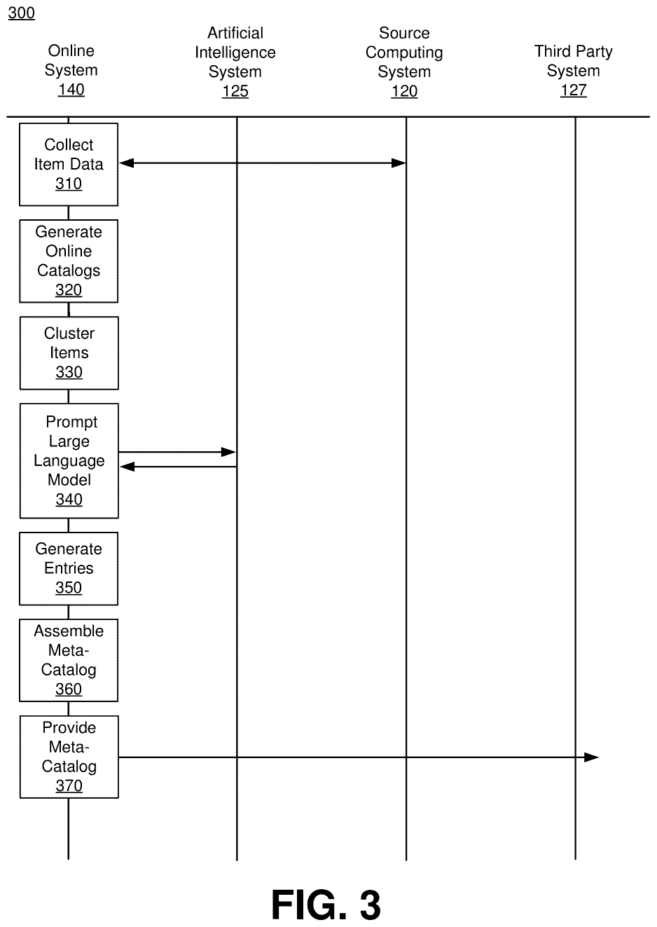

FIG. 3 forms an example sequence diagram 300 describing generation of a meta-catalog using a plurality of online catalogs of items, in accordance with some embodiments. Alternative embodiments may include more, fewer, or different interactions from those illustrated in FIG. 3, and the steps may be performed in a different order from that illustrated in FIG. 3. Alternative embodiments may include more, fewer, or different components from those illustrated in FIG. 3, and the functionality of each component may be divided between the components differently from the description below. For example, some or all of the functionality of the AI system 125 may be performed by the online system 140.

The online system 140 collects 310 some item data for items sold by source(s) of the source computing system 120. The item data may include, e.g., names of items being sold, item descriptions, pictures of items, pricing information, availability information, etc. Pricing information and availability information may differ for different source locations (e.g., different store locations), and in some cases for items to be sold online without a specific source location specified. While a single source computing system 120 is shown, in other embodiments, the online system 140 also collects item data from additional source computing systems for one or more other sources.

The online system 140 generates 320 a plurality of online catalogs of items using the collected item data. The online system 140 generates a separate online catalog of items for each source location of each source computing system, and may also generate a separate online catalog of items for each source computing system for items to be sold online without a specific source location specified. The online system 140 may determine item categories (e.g., via a clustering algorithm, a replacement model, etc.) for items, and update the item data (and associated online catalog) for each of the items with the determined item categories. The online system 140 may store the plurality of online catalogs of items in a data store (e.g., the data store 240).

The online system 140 clusters 330 items in the plurality of online catalogs of items. Each cluster of items describes a different meta-product. The online system 140 may cluster the items based in part on similarity of the items, such that each cluster is associated with a different meta-product and describes all items for that meta-product. For example, the meta-catalog module 205 may group items from the plurality of online catalogs of items by item category. In one or more embodiments, the meta-catalog module 205 clusters the items using embeddings associated with each item, such as by using a nearest neighbor clustering algorithm on the emebddings. The online system 140 records the mapping between meta-products and corresponding clusters of items as meta-linking data. The online system 140 may store the meta-linking data in the data store.

The online system 140 prompts 340 a large language model (e.g., of the AI system 125) with prompt(s) to determine information used to generate entries for a meta-product catalog. The online system 140 may retrieve descriptions (and in some cases container data or size data) of the clustered items from item data associated with the items in the clusters. The prompt(s) include one or more prompts to generate descriptions for meta-products that are associated with the clusters based on the retrieved descriptions (and in some cases container data or size data). For example, a first cluster of items may all be associated with a first meta-product (e.g., “Greek Yogurt”), and a prompt may be to generate a generic description for the first meta-product based in part on descriptions associated with the items in the first cluster, and in some embodiments, also based in part on size data of the items in the first cluster or container data of the items in the first cluster. The online system 140 applies the one or more prompts to the large language model. The large language model generates descriptions for each of the meta-products. The generated descriptions for the meta-products are output to the online system 140.

In some embodiments, the prompt(s) also include one or more prompts to generate meta-product images for the meta-products based in part on the descriptions of the meta-products (and in some cases also container data or size data of items in clusters associated with the meta-products). For example, a prompt may instruct the large language model to generate a meta image for a first meta-product (e.g., “Greek Yogurt”) using the description for the first meta-product. In another example, a prompt may instruct the large language model to generate a meta image for a first meta-product (e.g., “Greek Yogurt”) using the description for the first meta-product in addition to container data and size data of items in a cluster associated with the first meta-product. The online system 140 applies the one or more prompts to the large language model. The large language model generates meta-product images for the meta-products. The generated meta-product images for the meta-products are output to the online system 140. In some embodiments, the online system 140 may also post process meta-product images to identify and remove extraneous text from the meta-product images.

The online system 140 generates 350 entries for meta-products. The online system 140 generates entries for the meta-products, such that each meta-product has a corresponding entry. The online system 140 generates entries for the meta-products using in part the generated descriptions (e.g., a name and synopsis of the meta-product) for the meta-products. In some embodiments, the online system 140 may also use meta-product images in the generation of entries, such that an entry for a meta-product includes both a meta-product image as well as a description for that meta-product.

The online system 140 assembles 360 a meta-catalog for the meta-products using the entries. The online system 140 then provides 370 the meta-catalog to third party system 127. The third party system 127 may integrate or use the meta-catalog to provide services to users of user client devices (e.g., the user client device 100).

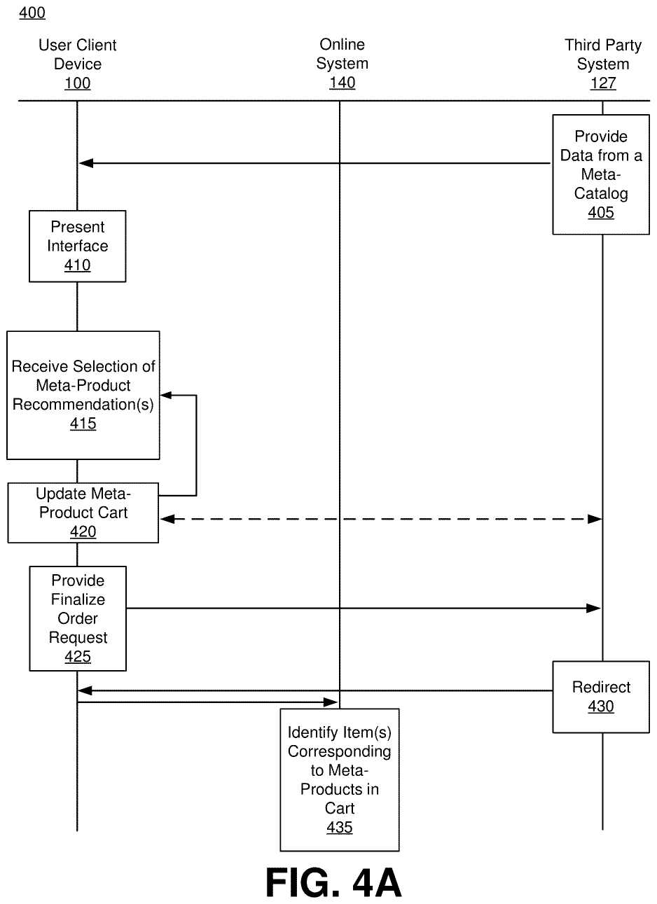

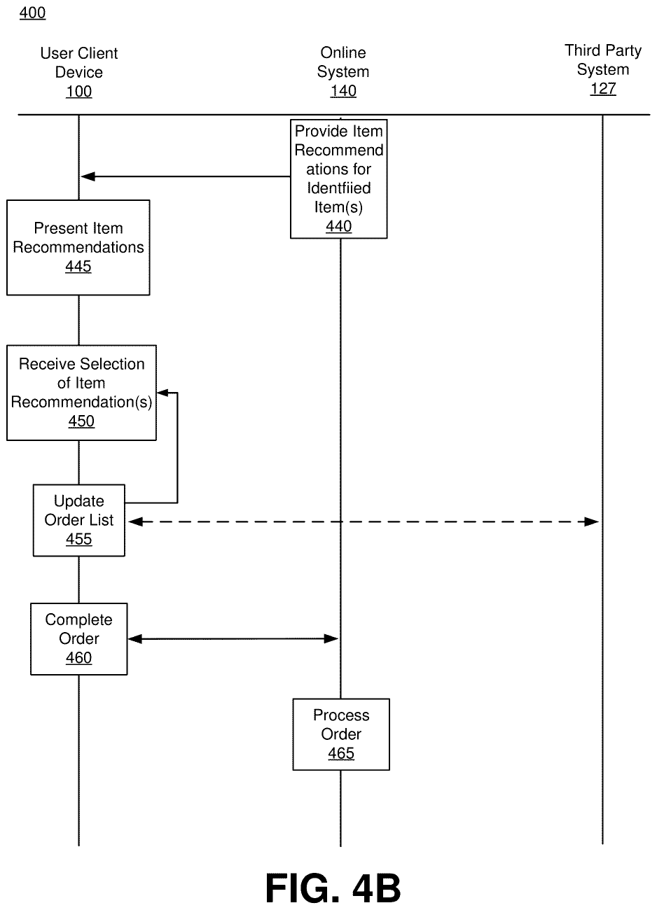

FIGS. 4A-4B form an example sequence diagram 400 describing use of a meta-catalog, in accordance with some embodiments. Alternative embodiments may include more, fewer, or different interactions from those illustrated in FIGS. 4A-4B, and the steps may be performed in a different order from that illustrated in FIGS. 4A-4B. Alternative embodiments may include more, fewer, or different components from those illustrated in FIGS. 4A-4B, and the functionality of each component may be divided between the components differently from the description below.

The third party system 127 provides 405 data from a meta-catalog to the user client device 100. The meta-catalog is an embodiment of the meta-catalog described above with regard to FIGS. 1-3. The data may be, e.g., information describing (e.g., meta-product recommendations, descriptions of meta-products, meta-product images) one or more meta-products in the meta-catalog. For example, the data may include meta-product recommendations for meta-products in the meta-product catalog. In some embodiments, the third party system 127 may also provide an interface to the user client device 100 to present the data.

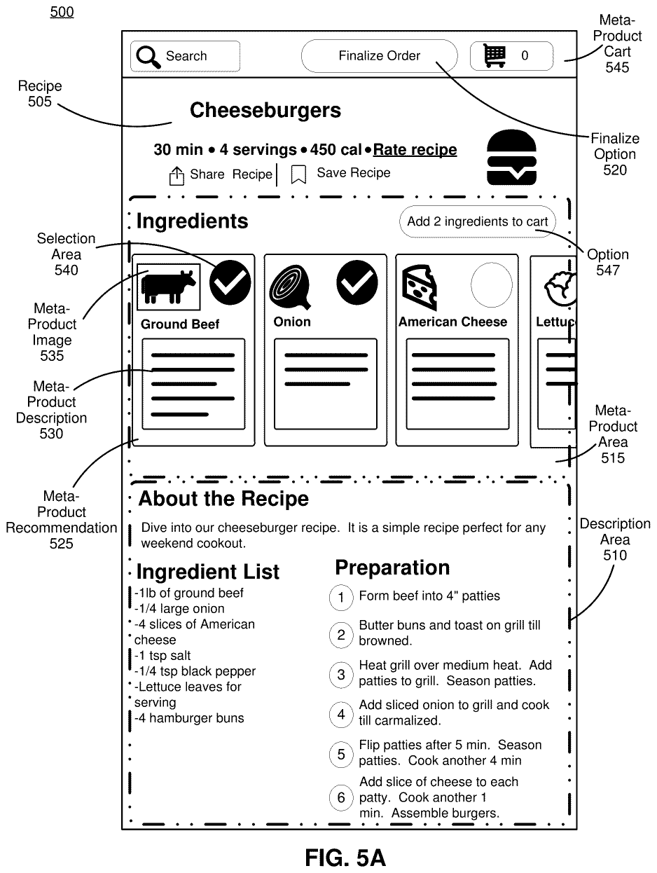

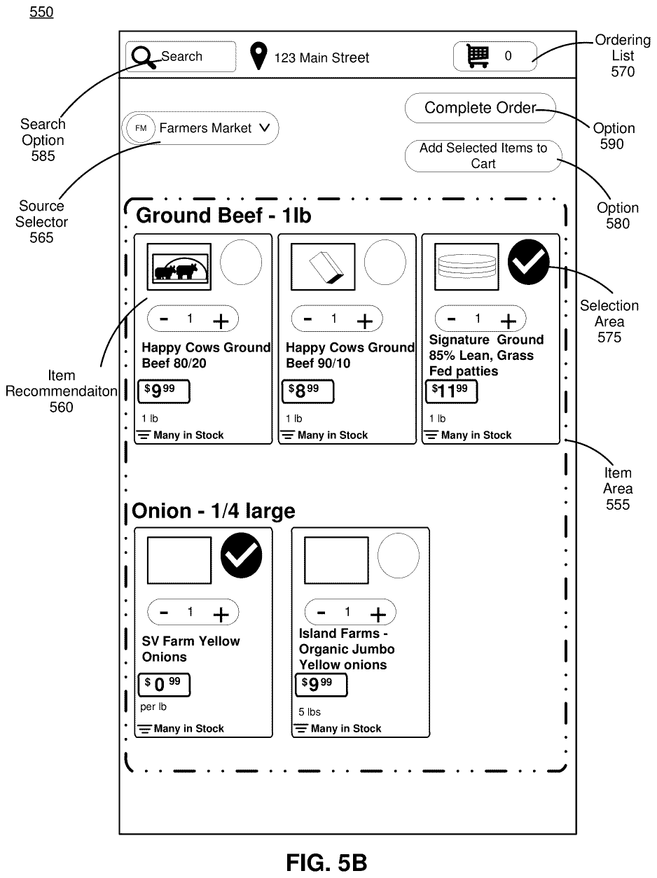

The user client device 100 presents 410 an interface. The interface includes at least some of the data (e.g., meta-product recommendations) from the meta-catalog. In some embodiments, the interface may be received from the third party system 127 or be part of an application running on the user client device 100. For example, the interface may present meta-products that correspond to ingredients of a recipe that a user of the user client device 100 can select. An example of the interface is described below with regard to FIG. 5A.

The user client device 100 receives 415 a selection of one or more meta-product recommendations. For example, a user may select one or more meta-product recommendations that are associated with corresponding meta-products. Responsive to the selection, the user client device 100 may update 420 a meta-product cart with the meta-products corresponding to the selected meta-product recommendations. In some embodiments, updating the meta-product cart may include coordinating with the third party system 127 to update the meta-product cart.

At some point, the user may be ready to finalize an order for meta-product(s) that are in the meta-product cart and select an option to finalize the order. Responsive to the selection, the user client device 100 provides 425 a finalize order request to the third party system 127.

Responsive to receiving the finalize order request, the third party system 127 redirects 430 the user client device 100 to the online system 140. In the illustrated embodiment, the user client device 100 works directly with the online system 140 to complete the order. In other embodiments (not shown), the third party system 127 acts as an intermediary with the online system 140 such that the user client device 100 is communicating through the third party system 127 with the online system 140 to complete the order.

The online system 140 identifies 435 items that correspond to the meta-products in the cart. The online system 140 may retrieve meta-linking data from a data store (e.g., the data store 240). The online system 140 may use the meta-linking data to identify what cluster(s) of items are associated with the meta-product(s) in the cart. Each meta-product is associated with a different cluster of items. The online system 140 may then retrieve item data for items in the identified clusters. The online system 140 may, for each meta-product, score the items of the cluster associated with the meta-product based in part on various criteria (e.g., location of the user, availability of the items at one or more sources within a threshold distance from the location, user preferences, etc.), and then rank the scored items. The online system 140 may select (e.g., top 3) one or more items from each ranked set of items for each cluster. In this manner, for each meta-product the online system 140 identifies corresponding items for presentation to the user of the user client device 100. The online system 140 provides 440 item recommendations for the identified item(s) to the user client device 100.

The user client device 100 presents 445, via an ordering interface, the item recommendations that correspond to the meta-products in the order. The ordering interface may present, for each meta-product, item recommendations for items that correspond to that meta-product. An example of the ordering interface is described below with regard to FIG. 5B. The ordering interface may indicate which source location(s) the items are available at, and item recommendations (e.g., may include descriptions for the items, pricing information for the items, etc.) for the items that correspond to the meta-products in the order.

The user client device 100 receives 450 a selection of one or more item recommendations. In some embodiments, the user selects one or more items recommendations for items that correspond to one or more meta-products in the order. For example, the item recommendations may provide several options of items that a user can choose from which correspond to a particular meta-product. In some embodiments, the user may not find an item that they feel corresponds to a meta-product. In these embodiments, the user may search for the item using the ordering interface to obtain an updated list of items, and select from the updated list of items to add to the ordering list. Responsive to the selection, the user client device 100 may update 455 the ordering list. In some embodiments, updating the ordering list may include coordinating with the online system 140 to update the ordering list.

At some point, the user may be ready to complete the order for the item(s) in the ordering list and select an option to complete the order. Responsive to the selection, the user client device 100 coordinates with the online system 140 to complete 460 the order.

The online system 140 processes 465 the completed order. The online system 140 may, e.g., identify a picker from a pool of pickers based on their locations relative to a source location for the items in the order, available cargo capacities of their vehicles, picker efficiency scores, size and number of requested items, etc. The online system 140 assigns the picker to handle the order. The online system 140 provides the assignment of the order to the picker client device 110 associated with the picker.

FIG. 5A illustrates an interface 500 of a third party system (e.g., the third party system 127) that is presenting meta-products from a meta-catalog, in accordance with some embodiments. The interface 500 may be presented on the user client device 100 of a user. In the illustrated embodiment, the interface 500 is a user interface that a user can use to, e.g., search for recipes. For example, the user may have searched for a recipe for cheeseburgers and been presented with a recipe 505 for cheeseburgers. The interface 500 may present meta-products from a meta-catalog of the online system 140 that correspond to ingredients for the recipes. In the illustrated embodiment, the interface 500 includes at least a description area 510, a meta-product area 515, and a finalize option 520. In other embodiments, the interface 500 includes different or additional elements. In addition, the functions may be distributed among the elements in a different manner than described.

The description area 510 presents recipe data associated with the recipe 505. The description area 510 includes a description of the recipe 505, an ingredient list for the recipe 505, and preparation steps for the recipe 505.

The meta-product area 515 presents meta-product recommendations (e.g., meta-product recommendation 525) that are ingredients of the recipe 505. The presented meta-product recommendations each correspond to a different meta-product in the meta-catalog. In the illustrated embodiments, each meta-product recommendation includes a meta-product description, a meta-product image, and a selection area. For example, the meta-product recommendation 525 for a meta-product (e.g., Ground Beef) includes a meta-product description 530 of that meta-product, a meta-product image 535 for that meta-product, and a selection area 540. The user may scroll through the various meta-product recommendations for the recipe 505.

The user may select one or more of the meta-product recommendations for meta-products to add their corresponding meta-products to a meta-product cart 545. For example, the user may select, using the selection areas (e.g., the selection area 540), one or more meta-product recommendations, and select an option 547 to add meta-products associated with the selected meta-product recommendations to the meta-product cart 545. In FIG. 5A the option 547 is a soft button, but in other embodiments, the option 547 may take some other form (e.g., hyperlink).

A user of the user client device 100 may finalize the order by selecting the finalize option 520. Responsive to selection of the finalize option 520, the user client device 100 may be redirected to the online system 140 to complete an order for items corresponding to meta-products in the meta-product cart 545.

FIG. 5B illustrates an example ordering interface 550 presenting item recommendations for items corresponding to meta-products, in accordance with some embodiments. In the illustrated embodiment, a user of the interface 500 had selected two meta-products (i.e., ground beef and onion), and added the two meta-products to the meta-product cart (e.g., the meta-product cart 545). The user then selected a complete order option (e.g., the finalize option 520). The user client device 100 was then redirected to the online system 140, and the user client device 100 presents the ordering interface 550. The ordering interface 550 is an embodiment of the ordering interface described above with regard to FIGS. 1, 2, and 4B. The ordering interface 550 is a user interface that presents item recommendations for items that correspond to meta-products in an order the user started with a third party system. In the illustrated embodiment, the ordering interface 550 includes an item area 555, and an option 590 to complete the order. In other embodiments, the ordering interface 550 includes different or additional elements. In addition, the functions may be distributed among the elements in a different manner than described.

The item area 555 presents information describing item recommendations (e.g., item recommendation 560) that correspond to the meta-products the user had previously selected to order (e.g., via the interface in FIG. 5A). The ordering interface 550 receives item recommendations for each of the selected meta-products from the online system 140 and presents them as part of the item area 555. In this example, the meta-product (Ground Beef) has three item recommendations that are available at a source (Farmers Market), and another meta-product (Onion) has two item recommendations that are available at the same source. Each item recommendation, for a meta-product, describes a different item that corresponds to the meta-product.

In the illustrated embodiment, a user can change which source is associated with the item recommendations using a source selector 565. For example, the user may use the source selector 565 to change the source for the item recommendations from Farmers Market to some other source (e.g., one previously used by the user, within a threshold distance to the user, etc.).

The user may select one or more of the item recommendations for adding to an ordering list 570. For example, the user may select, using selection areas (e.g., the selection area 575), one or more item recommendations, and select an option 580 to add items associated with the selected item recommendations to the ordering list 570. In FIG. 5B the option 580 is a soft button, but in other embodiments, the option 580 may take some other form (e.g., hyperlink).

In some embodiments, the presented item recommendations for a particular meta-product may not satisfy the user. The user may search the online system 140 for additional items using, e.g., a search option 585. The online system 140 may provide an updated list of item recommendations responsive to a received search request that are presented via the ordering interface 550. The user may also select items from updated list of items to add to the ordering list 570.

At some point, the user may be ready to complete the order for the item(s) in the ordering list 570 and select an option 590 to complete the order. Responsive to the selection, the user client device 100 coordinates with the online system 140 to complete the order for items that have been added to the ordering list 570.

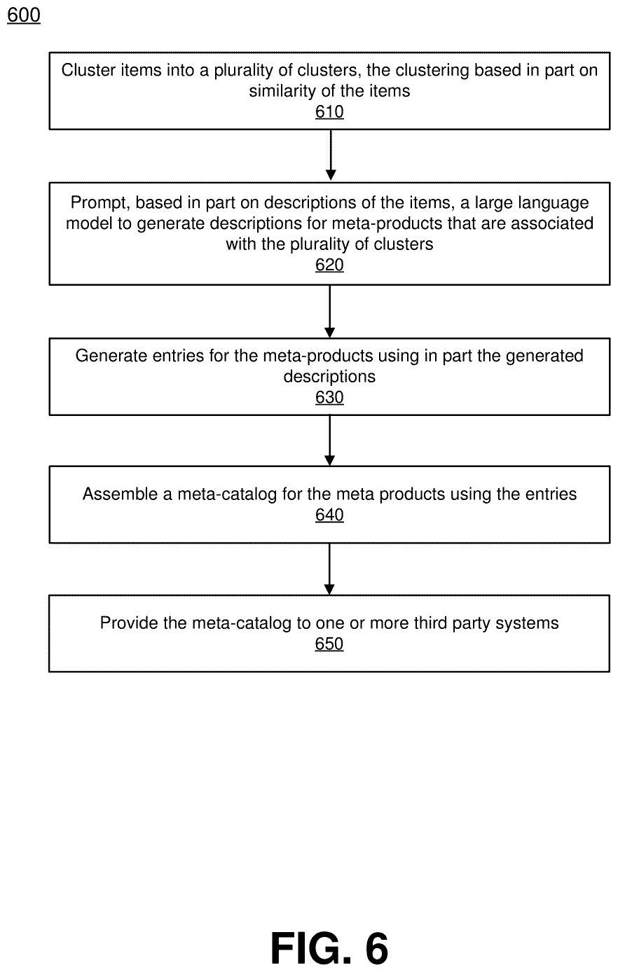

FIG. 6 is a flowchart for a method 600 of generation of a meta-catalog using a large language model, in accordance with some embodiments. Alternative embodiments may include more, fewer, or different steps from those illustrated in FIG. 6, and the steps may be performed in a different order from that illustrated in FIG. 6. These steps may be performed by an online system (e.g., online system 140). Additionally, each of these steps may be performed automatically by the online system without human intervention.

The online system clusters 610 items into a plurality of clusters, the clustering based in part on similarity of the items. The items being clustered are from a plurality of online catalogs that are associated with a plurality of sources, and each cluster is associated with a different meta-product. The online system may cluster the items based on, e.g., item category. In some embodiments, the online system may cluster the items using a clustering algorithm or replacement model. The online system may record the mapping between meta-products and corresponding clusters of items as meta-linking data. The meta-linking data may later be used to determine what cluster of items is mapped to a particular meta-product.

The online system prompts 620, based in part on descriptions of the items, a large language model to generate descriptions for meta-products that are associated with the plurality of clusters. The online system 140 may retrieve descriptions (and in some cases container data or size data) of the clustered items from associated item data. The online system generates one or more prompts for application to the large language model to generate descriptions for meta-products that are associated with the clusters based on the retrieved descriptions (and in some cases container data or size data). The online system 140 applies the one or more prompts to the large language model which outputs descriptions for the meta-products that are associated with the clusters. In some embodiments, the online system also generates one or more prompts for application to the large language model to generate meta-product images for the meta-products based in part on the descriptions of the meta-products (and in some cases also container data or size data). The online system applies the one or more prompts to the large language model which outputs meta-product images for the meta-products. In some embodiments, the online system may also post process meta-product images to identify and remove extraneous text.

The online system generates 630 entries for the meta-products using in part the generated descriptions. The online system generates entries for the meta-products, such that each meta-product has a corresponding entry. The online system generates entries for the meta-products using in part the generated descriptions (e.g., a name and synopsis of the meta-product) for the meta-products. In some embodiments, the online system may also use meta-product images in the generation of entries, such that an entry for a meta-product includes both a meta-product image as well as a description for that meta-product.

The online system assembles 640 a meta-catalog for the meta-products using the entries.

The online system provides 650 the meta-catalog to one or more third party systems. A user interacting with a third party system, of the one or more third party systems, via their user client device (e.g., the user client device 100) may select one or more meta-products from the meta-catalog for purchase. Once the user is ready to finalize an order for the selected meta-product(s), the user client device is redirected to the online system 140 to select item(s) corresponding to the meta-product(s) and complete the order.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
clustering items into a plurality of clusters, the clustering based in part on similarity of the items, where the items are from a plurality of online catalogs associated with a plurality of sources, and each cluster is associated with a different meta-product;
prompting, based in part on descriptions of the items, a large language model to generate descriptions for meta-products that are associated with the plurality of clusters;
generating entries for the meta-products using in part the generated descriptions;
assembling a meta-catalog for the meta-products using the entries;
providing the meta-catalog to a third party system;
receiving a request from the third party system, wherein the request specifies a meta-product from the meta-catalog and is responsive to an interaction with a user client device;
selecting an item from the cluster of items associated with the specified meta-product; and
responding to the request from the third party system using information about the selected item.

2. The method of claim 1, wherein prompting, based in part on the descriptions of the items, the large language model to generate descriptions for meta-products that are associated with the plurality of clusters, comprises:
prompting, based in part on size data of the items and the descriptions of the items, the large language model to generate descriptions for the meta-products that are associated with the plurality of clusters.

3. The method of claim 1, wherein prompting, based in part on the descriptions of the items, the large language model to generate descriptions for meta-products that are associated with the plurality of clusters, comprises:
prompting, based in part on container data of the items and the descriptions of the items, the large language model to generate descriptions for the meta-products that are associated with the plurality of clusters.

4. The method of claim 1, wherein the descriptions for meta-products includes a first description for a first meta-product, the method further comprising:
prompting the large language model to generate a meta-product image for the first meta-product of the meta-products based in part on the first description of the first meta-product,
wherein generating the entries for the meta-products using in part the descriptions of the meta-products, further comprises:
generating an entry for the first meta-product based in part on the first description of the first meta-product and the meta-product image.

5. The method of claim 4, further comprising:
post processing the meta-product image to identify extraneous text; and
updating the meta-product image by removing the extraneous text,
wherein generating the entry for the first meta-product based in part on the first description of the first meta-product and the meta-product image, comprises:
generating the entry using the updated meta-product image.

6. The method of claim 4, wherein prompting the large language model to generate a meta-product image for the first meta-product of the meta-products based in part on the first description of the first meta-product, comprises:
prompting the large language model to generate the meta-product image for the first meta-product based in part on the first description and size data of items in a cluster associated with the first meta-product.

7. The method of claim 4, wherein prompting the large language model to generate a meta-product image for the first meta-product of the meta-products based in part on the first description of the first meta-product, comprises:
prompting the large language model to generate the meta-product image for the first meta-product based in part on the first description and container data of items in a cluster associated with the first meta-product.

8. The method of claim 1, wherein clustering items into the plurality of clusters, the clustering based in part on similarity of the items, comprises:
retrieving item data that includes item categories for a subset of the items; and
clustering the subset of items based in part on the item categories.

9. The method of claim 1, wherein the large language model was trained by:
accessing a set of training examples including training item descriptions for a set of training clusters of items, wherein each training cluster of the set of training clusters is associated with a different training meta-product;
applying the large language model to the set of training examples to generate a training output corresponding to a set of predicted descriptions for training meta-products;
back-propagating one or more error terms obtained from one or more loss functions to update a set of parameters of the large language model, and one or more of the error terms are based on a difference between a label applied to a test interaction of the set of training examples and the set of predicted descriptions for training meta-products; and
stopping the back-propagation after the one or more loss functions satisfy one or more criteria.

10. The method of claim 1, further comprising:
identifying a cluster of items corresponding to the selected meta-product;
scoring the items of the cluster based in part on location of the user device and availability of the items at sources within a threshold distance from the location;
ranking the scored items; and
providing to the user client device, for presentation, item recommendations for at least some of the scored items based in part on their ranking.

11. The method of claim 1, further comprising:
generating, by the computer system, training examples based on meta-products selected by users in orders and corresponding items the users selected to fulfill the orders;
labeling each training example based on a comparison of a resolution of the training example to a metric associated with the computer system;
retraining the large language model using the labeled training examples;
prompting, based in part on descriptions of a subset of the items, the large language model to generate descriptions for meta-products that are associated with clusters, of the plurality of clusters, that are associated with the subset of the items;
updating entries for the meta-products that are associated with the clusters using in part the generated descriptions for the meta-products that are associated with clusters; and
updating the meta-catalog with the updated entries.

12. A computer program product comprising a non-transitory computer readable storage medium having instructions encoded thereon that, when executed by a processor of a computer system, cause the computer system to perform steps comprising:
clustering items into a plurality of clusters, the clustering based in part on similarity of the items, where the items are from a plurality of online catalogs associated with one or more sources, and each cluster is associated with a different meta-product;
prompting, based in part on descriptions of the items, a large language model to generate descriptions for meta-products that are associated with the plurality of clusters;
generating entries for the meta-products using in part the generated descriptions;
assembling a meta-catalog for the meta-products using the entries;
providing the meta-catalog to a third party system;
receiving a request from the third party system, wherein the request specifies a meta-product from the meta-catalog and is responsive to an interaction with a user client device;
selecting an item from the cluster of items associated with the specified meta-product; and
responding to the request from the third party system using information about the selected item.

13. The computer program product of claim 12, wherein the encoded instructions for prompting, based in part on the descriptions of the items, the large language model to generate descriptions for meta-products that are associated with the plurality of clusters, cause the computer system to perform steps comprising:
prompting, based in part on size data of the items and the descriptions of the items, the large language model to generate descriptions for the meta-products that are associated with the plurality of clusters.

14. The computer program product of claim 12, wherein the encoded instructions for prompting, based in part on the descriptions of the items, the large language model to generate descriptions for meta-products that are associated with the plurality of clusters, cause the computer system to perform steps comprising:
prompting, based in part on container data of the items and the descriptions of the items, the large language model to generate descriptions for the meta-products that are associated with the plurality of clusters.

15. The computer program product of claim 12, wherein the descriptions for meta-products includes a first description for a first meta-product, the computer program product further comprising encoded instructions that when executed cause the computer system to perform steps comprising:
prompting the large language model to generate a meta-product image for the first meta-product of the meta-products based in part on the first description of the first meta-product,
wherein generating the entries for the meta-products using in part the descriptions of the meta-products, further comprises:
generating an entry for the first meta-product based in part on the first description of the first meta-product and the meta-product image.

16. The computer program product of claim 12, wherein the encoded instructions for clustering items into the plurality of clusters, the clustering based in part on similarity of the items, cause the computer system to perform steps comprising:
retrieving item data that includes item categories for a subset of the items; and
clustering the subset of items based in part on the item categories.

17. The computer program product of claim 12, further comprising encoded instructions that when executed cause the computer system to perform steps comprising:
accessing a set of training examples including training item descriptions for a set of training clusters of items, wherein each training cluster of the set of training clusters is associated with a different training meta-product;
applying the large language model to the set of training examples to generate a training output corresponding to a set of predicted descriptions for training meta-products;
back-propagating one or more error terms obtained from one or more loss functions to update a set of parameters of the large language model, and one or more of the error terms are based on a difference between a label applied to a test interaction of the set of training examples and the set of predicted descriptions for training meta-products; and
stopping the back-propagation after the one or more loss functions satisfy one or more criteria.

18. The computer program product of claim 12, further comprising encoded instructions that when executed cause the computer system to perform steps comprising:
identifying a cluster of items corresponding to the selected meta-product;
scoring the items of the cluster based in part on location of the user and availability of the items at sources within a threshold distance from the location;
ranking the scored items; and
providing to the user client device, for presentation, item recommendations for at least some of the scored items based in part on their ranking.

19. The computer program product of claim 12, further comprising encoded instructions that when executed cause the computer system to perform steps comprising:
generating, by the computer system, training examples based on meta-products selected by users in orders and corresponding items the users selected to fulfill the orders;
labeling each training example based on a comparison of a resolution of the training example to a metric associated with the computer system;
retraining the large language model using the labeled training examples;
prompting, based in part on descriptions of a subset of the items, the large language model to generate descriptions for meta-products that are associated with clusters, of the plurality of clusters, that are associated with the subset of the items;
updating entries for the meta-products that are associated with the clusters using in part the generated descriptions for the meta-products that are associated with clusters; and
updating the meta-catalog with the updated entries.

20. A computer system comprising:
a processor; and
a non-transitory computer readable storage medium having instructions encoded thereon that, when executed by the processor, cause the computer system to perform steps comprising:
clustering items into a plurality of clusters, the clustering based in part on similarity of the items, where the items are from a plurality of online catalogs associated with a plurality of sources, and each cluster is associated with a different meta-product;
prompting, based in part on descriptions of the items, a large language model to generate descriptions for meta-products that are associated with the plurality of clusters;
generating entries for the meta-products using in part the generated descriptions;
assembling a meta-catalog for the meta-products using the entries;
providing the meta-catalog to a third party system;
receiving a request from the third party system, wherein the request specifies a meta-product from the meta-catalog and is responsive to an interaction with a user client device;
selecting an item from the cluster of items associated with the specified meta-product; and
responding to the request from the third party system using information about the selected item.
